(19) United States
(12) Patent Application Publication
(10) Pub. No.: US 2004/0162822 A1
(43) Pub. Date: Aug. 19, 2004

(54) Method and apparatus for converting in-line database queries to stored procedures

(76) Inventors: Khachatur Papanyan, Austin, TX (US); Brian L. Kaisner, Austin, TX (US); Ken Maranian, Austin, TX (US); Jody M. Smith, Austin, TX (US)

Correspondence Address: HAMILTON & TERRILE, LLP, P.O. BOX 203518, AUSTIN, TX, 78720, US

(21) Appl. No.: 10/365,929

(22) Filed: Feb. 13, 2003

(51) Int. Cl. G06F 17/30; G06F 7/00

(52) U.S. Cl. 707/4

(57) ABSTRACT

Converting an inline database query to a stored procedure which includes receiving an inline database query, determining from a mapping table whether an equivalent stored procedure exists, using the generic version of the inline database query to produce a stored procedure in case the stored procedure does not exist, and executing the stored procedure instead of the inline database query to speed the data retrieval from the database.

### BACKGROUND OF THE INVENTION

1. Field of the Invention

The present invention relates generally to database systems, and more particularly to automatically converting in-line queries to stored procedures.

2. Description of Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One use of information handling systems is in the field of database management. Databases facilitate storage and retrieval of information. No matter how fast the technology becomes, it is desirable to store data in an organized matter, and it is desirable to retrieve that data as fast as possible. Stored procedures are known to provide a fast and efficient mechanism for retrieving data from a database.

In many database backed applications, developers use an “inline” query to retrieve a dataset from the database. An inline query is a sequence of database statements in the code, possibly constructed dynamically via string manipulations, which will be sent to the database for execution. For the query to return the dataset, the query is passed to the database server. The database server parses the query string, creates an execution plan, executes the query per the plan, and returns the data to the application. Inline queries are comparably slow because the database server parses the query and creates an execution plan every time the query is processed. Even if the database has an algorithm for caching queries, the size of the cache is limited, thus forcing the database server to reevaluate a query multiple times when it gets pushed out of the cache.

A faster and more efficient method of retrieving a dataset from a database is to convert the query to a stored procedure. A stored procedure is a precompiled query that is stored in the database. The application passes parameters to the stored procedure and the stored procedure returns the data set. Because the stored procedure already has an execution plan, retrieving the data is considerably faster than with an inline query.

Stored procedures may be problematic as the stored procedures are relatively static compared to inline queries. Since the inline queries may be handled as strings, they can be constructed based on the business logic of the application. The columns to be selected, the tables to be joined, and the constraints of the query can all be constructed by the application logic on-the-fly. Stored procedures, on the other hand, are precompiled and cannot be altered by the application code. Often, numerous stored procedures need written to cover all the variations of one dynamic inline query. It is desirable to have the execution speed of stored procedures, yet still have the dynamic flexibility of inline queries.

### SUMMARY OF THE INVENTION

The invention sets forth a system and method to automatically convert inline queries to stored procedures for faster execution. Once the inline query reaches the method, the method queries the mapping table for an equivalent stored procedure. If none is found, the method creates the stored procedure on the database server. The next time the same query reaches the method, the method matches the inline query to the stored procedure on the database server and executes the stored procedure. Accordingly, the execution time of the inline query matches the speed of an equivalent stored procedure.

In one embodiment, the invention relates to a method for converting an inline database query to a stored procedure database query which includes receiving an inline database query, determining whether a generic version of the inline database query is present in a mapping table and, using the generic version of the inline database query to produce a stored procedure database query when the generic version of the inline database query is present in the mapping table.

In another embodiment, the invention relates to a database system for converting an inline database query to a stored procedure database query which includes a stored procedure module. The stored procedure module includes a receiving module, a determining module and a generic version module. The receiving module receives an inline database query. The determining module determines whether a generic version of the inline database query is present in a mapping table. The generic version module uses the generic version of the inline database query to produce a stored procedure database query when the generic version of the inline database query is present in the mapping table.

In another embodiment, the invention relates to an information handling system comprising database system for converting an inline database query to a stored procedure database query which includes a processor, a memory coupled to the processor, a stored procedure module coupled to the database. The memory stores a database and the stored procedure module converts an inline database query to a stored procedure database query. The stored procedure module includes a receiving module, a determining module and a generic version module. The receiving module receives an inline database query. The determining module determines whether a generic version of the inline database query is present in a mapping table. The generic version module uses the generic version of the inline database query to produce a stored procedure database query when the generic version of the inline database query is present in the mapping table.

In another embodiment, the invention relates to an apparatus for converting an inline database query to a stored procedure database query which includes a mapping table, means for receiving an inline database query, means for determining whether a generic version of the inline database query is present in the mapping table and, means for using the generic version of the inline database query to produce a stored procedure database query when the generic version of the inline database query is present in the mapping table. The mapping table stores generic versions of database queries.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of a database system including a stored procedure module.

FIG. 2 shows a flow chart of the operation of a stored procedure module.

FIG. 3 shows a block diagram of a portion of an exemplative stored procedure module.

FIG. 4 shows a block diagram of an information handling system.

### DETAILED DESCRIPTION

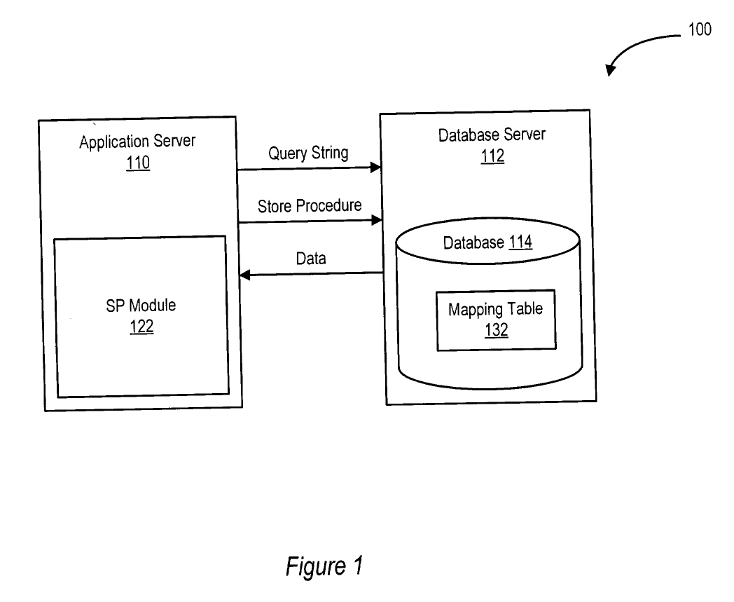

Referring to FIG. 1, the database system 100 includes an application server 110 coupled to a database server 112 which contains a database 114 and a database server stored procedure module 122. The application server 110 includes an application server stored procedure module 122. A client computer sends a request to the application server 110. The application server 110 communicates with the database sever 112, sending a query string with stored procedure parameters. The database server 112 provides data which is accessed within the database 114 to the application server 110 based upon a database call from the application server 110.

The stored procedure module 122 enables the database server 112 to execute inline queries faster. More specifically, when an inline query reaches the stored procedure module 122, the stored procedure module 122 of the application server 110 parses the query, creates a stored procedure inside the database 114 on the database sever 112 and stores the stored procedure within a mapping table 132. Another time the same query reaches the stored procedure modulel22, the stored procedure module 122 matches the query to the stored procedure stored in the mapping table 132 and executes the stored procedure. Accordingly, the execution time of the inline query substantially corresponds to the speed of an equivalent stored procedure.

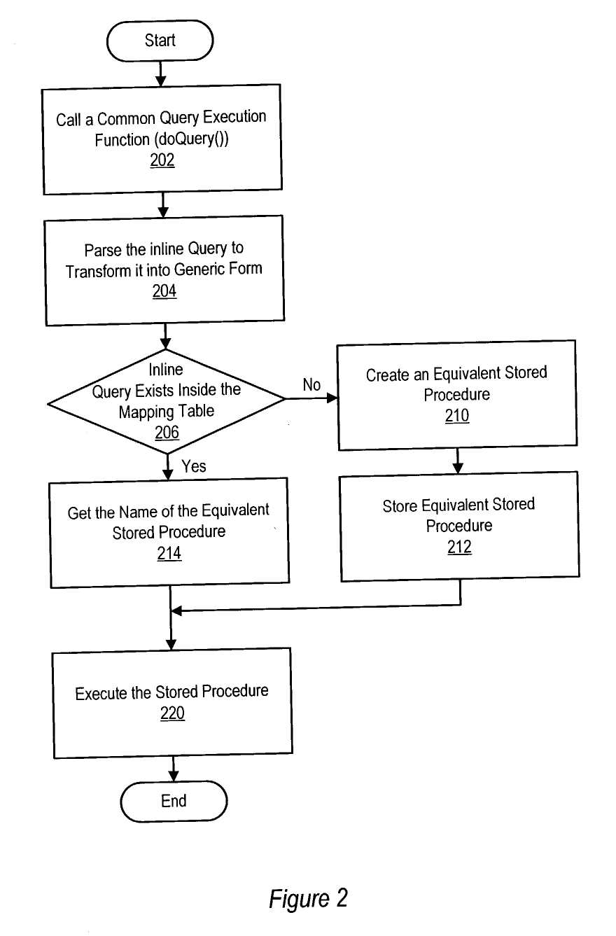

Referring to FIG. 2, a flow chart of the operation of a stored procedure module is shown. More specifically, the stored procedure module starts executing via a call to a common query execution function (doQuery( )) at step 202. The inline query is parsed to transform the inline query into a generic form at step 204, e.g., stored procedure module 122. Next, the inline query is analyzed to determine whether the query is present within the mapping table 132 of the database 114 at step 206. If the inline query is not present, then an equivalent stored procedure is created at step 210. The created equivalent stored procedure is stored in the database and referenced in the mapping table at step 212.

If the inline query is present within the mapping table 132, then the name of the equivalent stored procedure is obtained from the mapping table 132 at step 214.

Once the stored procedure is either created by step 210 or obtained by step 214, then the parameters of the inline query are provided to the stored procedure and the stored procedure is executed at step 220. Executing the stored procedure thus ultimately allows the database 114 to provide the requested data to the application server 110.

More specifically, rather than passing the query to the database server 112 and having the database server 112 cache the query, the stored procedure module 122 achieves efficiency gains by creating a stored procedure for each unique query. The stored procedure module 122 provides a common query execution function for the execution of all inline queries (such as doQuery( )) so that all queries can be captured and redirected to a query lookup mapping table stored within the database 114 of the database server 112.

Once an inline query string is constructed based upon the application logic, the application calls the common query execution function. Thus, the common query execution function parses the query rather than passing the inline query directly to the database 114 for execution.

The query execution function replaces the integer values within the query with generic integer parameters (e.g., “@param_xx_int”). The query execution function replaces all of the string values within the query with generic string parameters (e.g., “@param_xx_str”). Once the query is converted to a generic form, the stored procedure module 122 performs a lookup in the mapping table to determine whether this inline query has an equivalent stored procedure. If there is no match, the function constructs a query string for the creation of an equivalent stored procedure, executes the query string for the stored procedure, and adds an entry into the mapping table for the newly created stored procedure. The entry of the mapping table includes a generic form of the query as well as the stored procedure name.

If there is a match in the mapping table for an inline query, the query execution function retrieves the name of the equivalent stored procedure and executes the stored procedure with the parameter values extracted from the inline query. Accordingly, rather than letting the database server 112 parse the query and cache the execution plan in memory, where the execution plan has a chance of being de-allocated, the stored procedure module creates the stored procedure and stores the stored procedure name within the mapping table. Thus, with the common function implementation, a second execution of the inline query always produces a hit as compared with a database server caching implementation in which an inline query can miss.

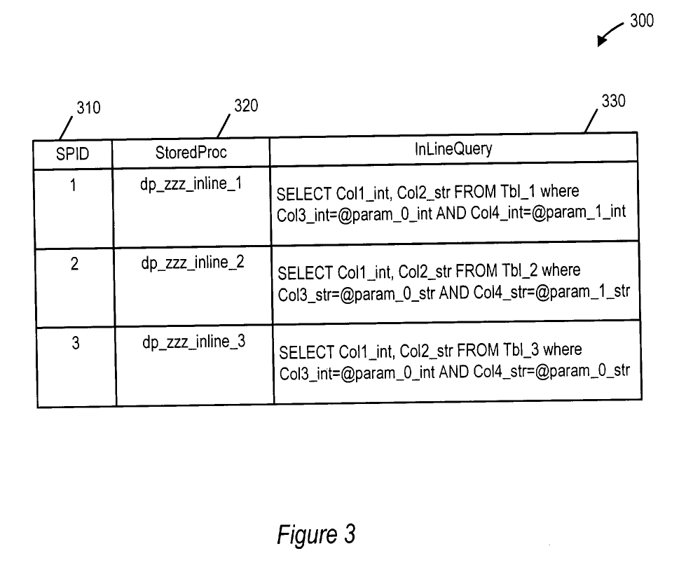

Referring to FIG. 3, a block diagram of a portion of an example mapping table 300 (same as mapping table 132 in FIG. 1) of stored procedure module 122 is shown. More specifically, the mapping table 300 includes a stored procedure identification portion (SPID) 310, a stored procedure name portion 320 and an in line query portion 330.

The stored procedure identification portion 310 provides a unique identifier for each stored procedure that is stored within the mapping table 300. The stored procedure name portion 320 provides a unique name for each stored procedure that is stored within the mapping table 300. The name may follow a naming convention which corresponds to the stored procedure, to the location of the stored procedure within the mapping table or some combination of these and other naming conventions.

The inline query portion 330 of the mapping table 300 sets forth the inline query which corresponds to a particular stored procedure. The inline query portion 330 also sets forth the generic integer parameters and generic string parameters as appropriate. For example, the stored procedure which corresponds to stored procedure identifier 3 includes an integer parameter corresponding to table column “Col3_mint” and a string parameter corresponding to table column “Col4_str.”

An area in which databases are useful is in the manufacture of information handling systems. Because information handling systems include many parts which are often changing, many database calls may be involved in the development and manufacture of an information handling system.

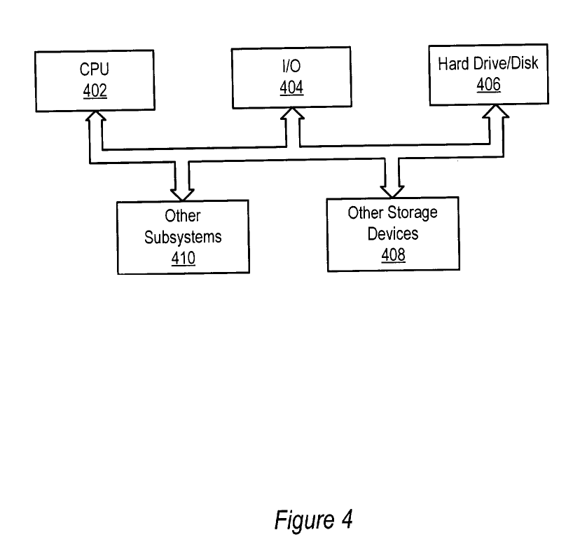

Also, the application server and the database server are often implemented as part of an information handling system. Referring to FIG. 4, a system block diagram of an information handling system is shown. The information handling system 400 includes a processor 402, input/output (I/O) devices, such as a display, a keyboard, a mouse, and associated controllers, collectively designed by a reference numeral 404, a hard disk and drive 406, and other storage devices, such as a floppy disk and drive and other memory devices, collectively designated by a reference numeral 408, and various other subsystems, collectively designated by a reference numeral 410, all interconnected via one or more buses, shown collectively as a bus 412.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Other Embodiments

Other embodiments are within the following claims.

What is claimed is:

1. A method for converting an inline database query to a stored procedure database query comprising:
receiving an inline database query;
determining whether a generic version of the inline database query is present in a mapping table; and,
using the generic version of the inline database query to produce a stored procedure database query when the generic version of the inline database query is present in the mapping table.

2. The method of claim 1 further comprising:
generating a generic version of the inline database query when a generic version of the inline database query is not present in the mapping table; and,
storing the generic version of the inline database query in the mapping table.

3. The method of claim I further comprising:
parsing the inline query to provide a generic version of the inline query; and,
using the generic version of the inline query to determine whether a generic version of the inline database query is present in the mapping table.

4. The method of claim 1 further comprising:
providing parameters from the inline database query to the stored procedure database query
using the parameters from the inline database query to execute the stored procedure database query.

5. A database system for converting an inline database query to a stored procedure database query comprising:
a stored procedure module, the stored procedure module including
a receiving module, the receiving module receiving an inline database query;
a determining module, the determining module determining whether a generic version of the inline database query is present in a mapping table; and,
a generic version module, the generic version module using the generic version of the inline database query to produce a stored procedure database query when the generic version of the inline database query is present in the mapping table.

6. The database system of claim 5 wherein the stored procedure module further comprises:
a generating module, the generating module generating a generic version of the inline database query when a generic version of the inline database query is not present in the mapping table; and,
a storing module, the storing module storing the generic version of the inline database query in the mapping table.

7. The database system of claim 5 wherein the stored procedure module further comprises:
a parsing module, the parsing module parsing the inline query to provide a generic version of the inline query; and,
an inline query module, the inline query module using the generic version of the inline query to determine whether a generic version of the inline database query is present in the mapping table.

8. The database system of claim 5 wherein the stored procedure module further comprises:
a parameter module, the parameter module providing parameters from the inline database query to the stored procedure database query and using the parameters from the inline database query to execute the stored procedure database query.

9. An information handling system comprising database system for converting an inline database query to a stored procedure database query comprising:
a processor;
a memory coupled to the processor, the memory storing a database; and
a stored procedure module coupled to the database, the stored procedure module converting an inline database query to a stored procedure database query, the stored procedure module including
a receiving module, the receiving module receiving an inline database query;
a determining module, the determining module determining whether a generic version of the inline database query is present in a mapping table; and,
a generic version module, the generic version module using the generic version of the inline database query to produce a stored procedure database query when the generic version of the inline database query is present in the mapping table.

10. The information handling system of claim 9 wherein the stored procedure module further comprises:
a generating module, the generating module generating a generic version of the inline database query when a generic version of the inline database query is not present in the mapping table; and,
a storing module, the storing module storing the generic version of the inline database query in the mapping table.

11. The information handling system of claim 9 wherein the stored procedure module further comprises:
a parsing module, the parsing module parsing the inline query to provide a generic version of the inline query; and,
an inline query module, the inline query module using the generic version of the inline query to determine whether a generic version of the inline database query is present in the mapping table.

12. The information handling system of claim 9 wherein the stored procedure module further comprises:
a parameter module, the parameter module providing parameters from the inline database query to the stored procedure database query and using the parameters from the inline database query to execute the stored procedure database query.

13. An apparatus for converting an inline database query to a stored procedure database query comprising:
a mapping table, the mapping table storing generic versions of database queries;
means for receiving an inline database query;
means for determining whether a generic version of the inline database query is present in the mapping table; and,
means for using the generic version of the inline database query to produce a stored procedure database query when the generic version of the inline database query is present in the mapping table.

14. The apparatus of claim 13 further comprising:
means for generating a generic version of the inline database query when a generic version of the inline database query is not present in the mapping table; and,
means for storing the generic version of the inline database query in the mapping table.

15. The apparatus of claim 13 further comprising:
means for parsing the inline query to provide a generic version of the inline query; and,
means for using the generic version of the inline query to determine whether a generic version of the inline database query is present in the mapping table.

16. The apparatus of claim 13 further comprising:
means for providing parameters from the inline database query to the stored procedure database query
means for using the parameters from the inline database query to execute the stored procedure database query.
